(19) United States
(12) Patent Application Publication
(10) Pub. No.: US 2005/0218162 A1
(43) Pub. Date: Oct. 6, 2005

(54) Valve actuating apparatuses and methods associated therewith

(76) Inventors: Brian E. Healy, Hartland, WI (US); Nathan R. Westphal, Union Grove, WI (US); Allen D. Miller, Racine, WI (US); Scott W. Demarest, Caledonia, WI (US); Simon M. Conway, Burlington, WI (US)

Correspondence Address: S.C. JOHNSON & SON, INC., 1525 HOWE STREET, RACINE, WI, 53403-2236, US

(21) Appl. No.: 10/877,162

(22) Filed: Jun. 25, 2004

Related U.S. Application Data
(63) Continuation-in-part of application No. 10/810,002, filed on Mar. 26, 2004.

(51) Int. Cl. B67D 5/06

(52) U.S. Cl. 222/402.1; 222/183

(57) ABSTRACT

A combination includes a container of product having a longitudinal dimension and a valve oriented to discharge product generally longitudinally from the container. A housing includes a first wall portion enclosing a main body of the container and a second tapered wall portion adjacent the first wall portion tapering to a discharge opening. The discharge opening has a cross sectional size larger than a radius of the container. Valve actuating apparatus extends laterally from the valve and has an interfering relationship with the first wall portion. Relative movement of the container toward the discharge opening causes the valve actuating apparatus to be displaced against the first wall portion to actuate the valve and dispense product from the housing.

### CROSS REFERENCE TO RELATED APPLICATIONS

The present application is a continuation-in-part of U.S. patent application Ser. No. 10/810,002, filed on Mar. 26, 2004.

### REFERENCE REGARDING FEDERALLY SPONSORED RESEARCH OR DEVELOPMENT

Not applicable

### SEQUENTIAL LISTING

Not applicable

### BACKGROUND OF THE INVENTION

1. Field of the Invention

The present invention relates generally to housings that hold containers, and more particularly to housings that hold containers and actuators that actuate valve apparatus to dispense product from the container.

2. Description of the Background of the Invention

Various apparatus for dispensing product from a container or reservoir of product have been developed. Smrt U.S. Pat. No. 5,287,998 discloses an actuator fitted to a container and including an axially extending passage therethrough for discharging product. The actuator includes a pair of wings that extend transversely from the actuator. The container may be moved axially within a device such that the wings bear against a surface defining a passage, thereby discharging product through the passage.

Brotspies et al. discloses a spray bottle grip used with a nasal spray bottle. The grip is coupled to a reciprocating nozzle of the spray bottle, and two arms extend downwardly along the spray bottle. The arms include finger flanges that provide an ergonomic means of reciprocating the nozzle to dispense product from the spray bottle.

Haas U.S. Pat. No. 3,318,492 discloses a disc-shaped actuator attached to a nozzle of a container. A user may depress the actuator with her finger to dispense product from the container.

Scheindel et al. U.S. Pat. No. 6,340,103 discloses a handle extending along a container body. When a user pulls the handle toward the container body, a portion of the handle pushes downwardly upon a nozzle portion of the container to dispense product from the container.

Micallef U.S. Pat. No. 4,138,039 discloses a container having a vertically reciprocating tubular pump. A cap is fitted to the container and includes an actuator button extending from a sidewall of the cap. Movement of the actuator button in a direction toward the sidewall of the cap is translated into perpendicular reciprocating movement of the pump.

Other patents disclose devices having a container of product disposed at a first end of a rod and having a trigger mechanism at a second end of the rod wherein a user may actuate the container from a distance. Discharging product from a distance can be an advantage for many purposes, such as accessing hard-to-reach places or perhaps for discharging an insecticide into a hornet nest without placing oneself too close to the nest. Smrt U.S. Pat. No. 5,518,148 discloses a device where an actuating rod has a trigger on a first end and a container on a second end. Pulling the trigger moves the actuating rod longitudinally such that the second end of the rod moves a bell crank, which in turn, moves an additional rod that actuates a valve on the container. Aberegg et al. U.S. Pat. No. 6,551,001, assigned to the assignee of the present application and the disclosure of which is incorporated by reference herein, discloses a cleaning device having a trigger at a first end of a rod and a mop cleaning head and a container at a second end of the rod. Pulling the trigger moves a pivot link, which in turn actuates a valve of the container, thereby discharging product from the container onto the surface to be cleaned by the mop cleaning head.

Adams et al. U.S. Pat. No. 5,358,147, assigned to the present assignee and also incorporated herein by reference, discloses a container of air freshener inserted into a shroud. The shroud includes a nozzle that is fitted over a valve stem of the container. The combination of the container and the shroud is placed within a housing. When a user wishes to spray air freshener into ambient air, the user pushes the housing, which in turn pushes the shroud and the valve stem to dispense the air freshener out of the housing.

### SUMMARY OF THE INVENTION

In accordance with one aspect of the present invention, a combination includes a container of product having a longitudinal dimension and a valve oriented to discharge product generally longitudinally from the container. A housing includes a first wall portion enclosing a main body of the container and a second tapered wall portion adjacent the first wall portion tapering to a discharge opening. The discharge opening has a cross sectional size larger than a radius of the container. Valve actuating apparatus extends laterally from the valve and has an interfering relationship with the first wall portion. Relative movement of the container toward the discharge opening causes the valve actuating apparatus to be displaced against the first wall portion to actuate the valve and dispense product from the housing.

In accordance with a further aspect of the present invention, a combination includes a container of product having a longitudinal dimension and a valve oriented to discharge product generally longitudinally from the container. A housing includes a first wall portion enclosing a main body of the container and a second tapered wall portion adjacent the first wall portion tapering to a discharge opening wherein the discharge opening has a cross sectional size larger than a radius of the container. An adapter is fitted to the housing, and relative movement of the container toward the discharge opening causes a surface of the adapter to contact valve actuating apparatus of the container to actuate the valve and dispense product from the housing.

A further aspect of the present invention comprehends a method of dispensing includes the step of selecting a container of product and valve actuating apparatus. The container has a longitudinal dimension and a valve oriented to discharge product generally longitudinally from the container. A housing is selected having a first wall portion enclosing a main body of the container and a second tapered wall portion adjacent the first wall portion. The second wall portion tapers to a discharge opening, and the discharge opening has a cross sectional size larger than a radius of the container. The container is placed within the housing. Valve actuating apparatus extends laterally from the valve and has an interfering relationship with the first wall portion. A relative movement of the container toward the discharge opening is provided such that the valve actuating apparatus is displaced against the first wall portion to actuate the valve and dispense product from the housing.

According to another aspect of the present invention a method of dispensing includes the step of selecting a container of product having a longitudinal dimension and a valve oriented to discharge product generally longitudinally from the container. A housing is selected having a first wall portion enclosing a main body of the container and a second tapered wall portion adjacent the first wall portion. The second wall portion tapers to a discharge opening, and the discharge opening has a cross sectional size larger than a radius of the container. An adapter is fitted to the housing. A relative movement of the container toward the discharge opening is provided such that valve actuating apparatus of the container engages a surface of the adapter to actuate the valve and dispense product from the housing.

Other aspects and advantages of the present invention will become apparent upon consideration of the following detailed description.

### BRIEF DESCRIPTION OF THE DRAWINGS

FIG. 1A is an exploded isometric view of a container and valve actuating apparatus;

FIG. 1B is an exploded isometric view showing a container having a female-type receiver valve;

FIG. 1C is an isometric view of valve actuating apparatus;

FIG. 1D is an isometric view of a valve stem having an arm extending therefrom;

FIG. 2 is an exploded isometric view of a housing into which the container of FIG. 1A may be placed;

FIG. 3 is a side elevational view of the housing of FIG. 2;

FIG. 4 is a sectional view taken generally along the lines 4-4 of FIG. 3 further illustrating the container of FIG. 1 in elevation;

FIG. 5 is an enlarged fragmentary view of FIG. 4;

FIG. 5A is an enlarged sectional view taken generally along the lines 5A-5A of FIG. 5;

FIG. 6 is a fragmentary exploded isometric view illustrating a nozzle that may be fitted to a valve stem;

FIG. 7 is an enlarged bottom elevational view of the nozzle of FIG. 6;

FIG. 8 is a side elevational view showing a rod and trigger mechanism in combination with the housing of FIG. 3;

FIG. 9 is a fragmentary partial sectional view taken generally along lines 9-9 of FIG. 8;

FIG. 10 is an isometric view of an alternative embodiment of valve actuating apparatus;

FIG. 11 is a fragmentary isometric view of the valve actuating apparatus of FIG. 10 disposed in the housing of FIG. 1A;

FIG. 12 is a sectional view taken generally along the lines 12-12 of FIG. 11;

FIG. 13 is a sectional view taken generally along the lines 13-13 of FIG. 11 and further illustrating the container of FIG. 1A in elevation;

FIG. 14 is an isometric view of a first embodiment of actuator adapter;

FIG. 15 is a fragmentary sectional view of the adapter of FIG. 14 fitted to a housing, similar or identical to the housing of FIG. 2, and further illustrating the container having valve actuating apparatus extending therefrom;

FIG. 16 is an isometric view of a second embodiment of actuator adapter showing spaced tabs represented by phantom lines;

FIG. 16A is a bottom elevational view of the actuator adapter of FIG. 16.

FIG. 16B is a sectional view taken generally along the lines 16B-16B of 16A;

FIG. 17 is a fragmentary sectional view illustrating the adapter of FIG. 16 fitted to a housing similar or identical the housing of FIG. 2;

FIG. 18 is an isometric view of a third embodiment of actuator adapter;

FIG. 19 is a plan view of the adapter of FIG. 18;

FIG. 20 is a sectional view taken generally along the lines 20-20 of FIG. 19 and further illustrating in section a container, valve actuating apparatus extending from the container, and a housing similar or identical to the housing shown in FIGS. 15 and 17;

FIG. 21 is an isometric view illustrating a cage, which may house the container of FIG. 1A;

FIG. 22 is a sectional view taken along the lines 22-22 of FIG. 21 and further illustrating the container of FIG. 1A in elevation; and

FIG. 23 is a fragmentary exploded isometric view illustrating a further embodiment of valve actuating apparatus.

### DETAILED DESCRIPTION OF THE PREFERRED EMBODIMENTS

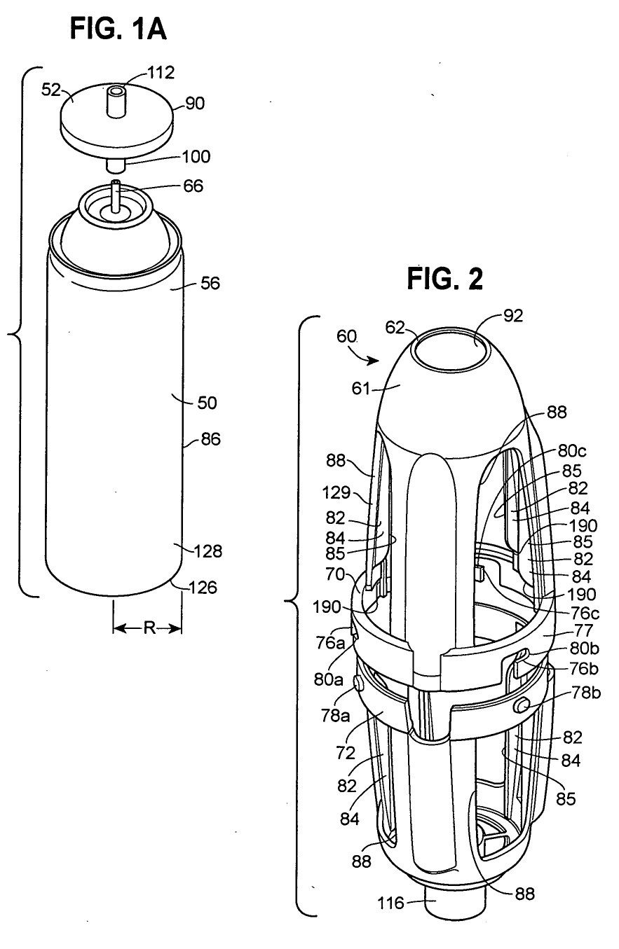

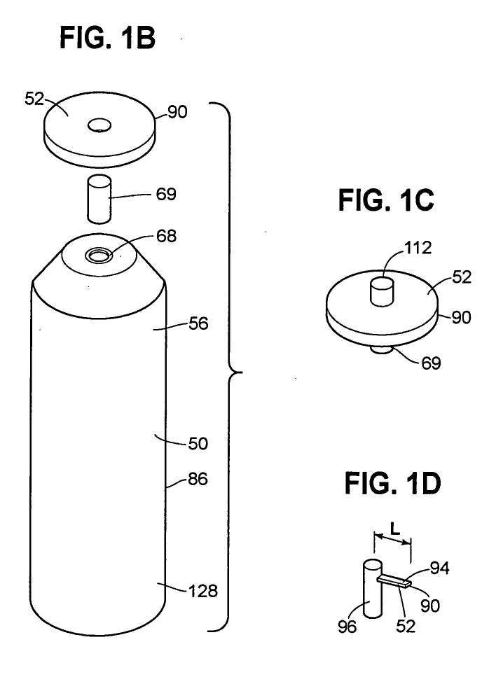

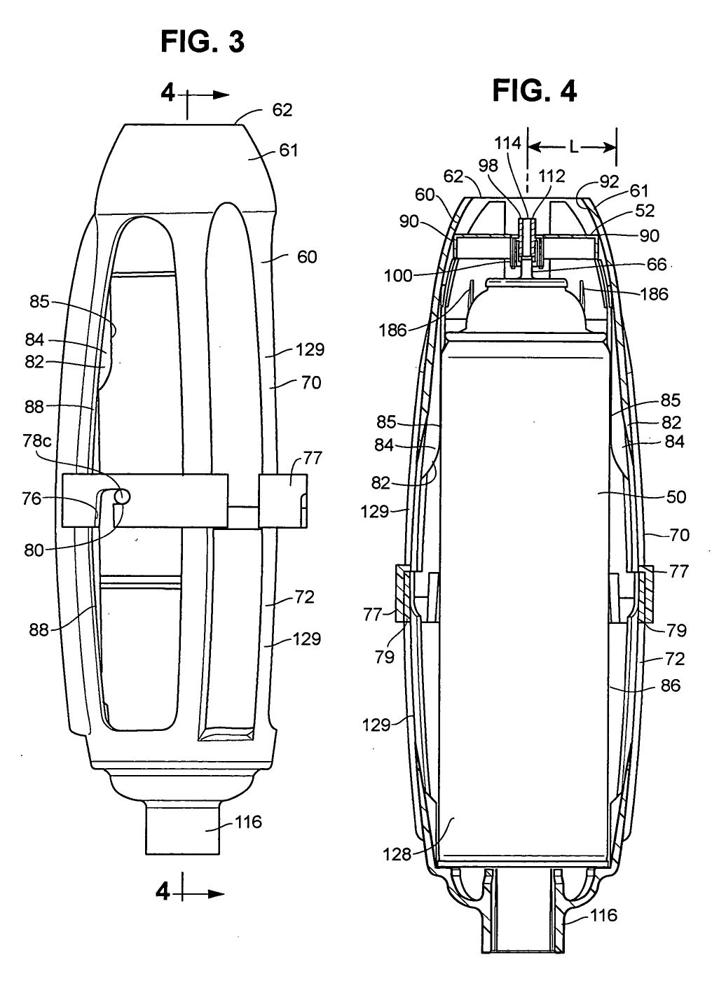

FIG. 1A illustrates a container 50 and a valve actuating apparatus 52 actuable to dispense product from the container 50. The container 50 includes a main container body 56 that contains product. Referring to FIG. 2, a housing 60 is provided, in which the container 50 may be placed. The housing 60 includes a wall 61 that decreases in cross sectional size, tapering to a discharge opening 62. The discharge opening 62 has a cross sectional size greater than a radius R of the container 50. The container 50 includes a valve stem 66 that actuates a valve (not shown) disposed within the container body 56, and product flows from the valve stem 66 in a direction substantially parallel to an axial dimension of the container 50. The valve stem 66 could be either a vertically depressible valve stem or a tilt valve stem. As will be appreciated hereinafter, if a tilt valve stem is utilized such stem could also alternatively be depressed vertically without tilting to dispense product therethrough. Referring to FIG. 1B, one could substitute the valve stem 66 with a female valve 68 that receives a suitable insertion tube 69. As shown in FIG. 1C, the insertion tube 69 could be integral with or secured to the valve actuating apparatus 52. Alternatively, the valve actuating apparatus 52 could be separable from the insertion tube 69. Similarly, it should be evident that the valve actuating apparatus 52 could be separable from the valve stem 66 or could be secured in fixed relation thereto or could be integral therewith. Referring again to FIG. 2, the housing 60 may include first and second wall portions 70, 72 that may be joined together to house the container 50. The portion 70 may include three bayonet slots 76a-76c disposed on an end 77 of the portion 70 and equally spaced from one another by 120 degrees. To join the portions 70, 72, a user inserts pins 78a-78c carried by an end 79 of the portion 72 into the slots 76a-76c and provides a relative rotation of the portions 70, 72 to seat the pins 78a-78c within recessed regions 80a-80c of the slots 76.

Either of the portions 70, 72 may include protrusions 82 such as guide fins 84 having edges 85 that abut an exterior surface 86 of the container 50 when the container 50 is placed therein to center the container 50 within the housing 60. Either of the portions 70, 72 may include elongate openings or windows 88 that allow a user to see the container 50 when the container is disposed within the housing 60. The windows 88 further provide an advantage in that the user may see written directions or graphics disposed on the container 50.

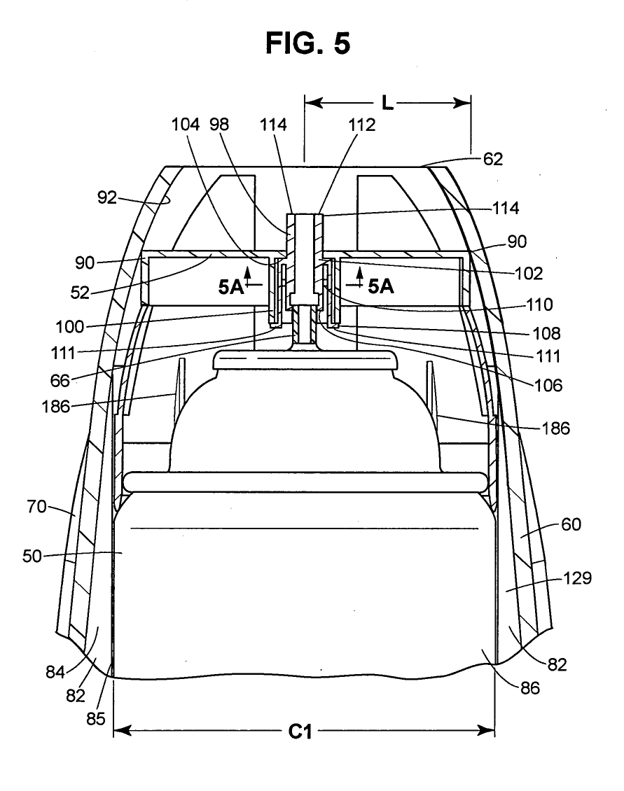

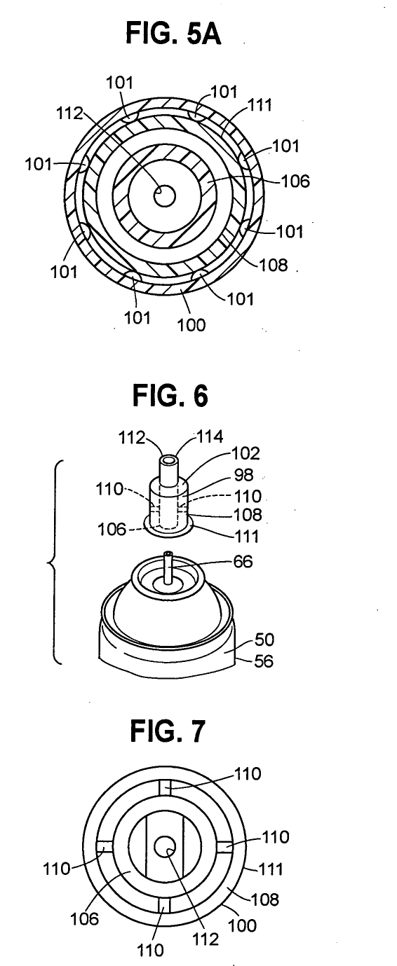

Referring to FIGS. 4 and 5, the valve actuating apparatus 52 extends in a direction transverse to a longitudinal dimension of the container 50. The valve actuating apparatus 52 has a length L defined between a center of the valve stem 66 and an outer peripheral surface 90 of the valve actuating apparatus 52. As seen in FIG. 5, the length L is selected relative to the inner dimensions of the wall 61 such that the outer peripheral surface 90 is disposed in interfering relationship with the wall 61. Relatively moving the container 50 and the housing 60 such that the main body 56 of the container 50 and the discharge opening 62 are moved toward each other causes the outer peripheral surface 90 to contact a surface 92 of the wall 61, thereby displacing the valve actuating apparatus 52 and dispensing product out of the discharge opening 62. It should be appreciated that the valve actuating apparatus 52 could be of any suitably shaped structure. For example, referring to FIG. 1D, the valve actuating apparatus 52 could include a single arm 94 having at least a portion of length L and extending from a tilt-type valve stem 96.

Referring to FIGS. 5-7, a nozzle 98 may be fitted to the valve stem 66 and the nozzle 98 may be fitted within a bore defined by a circumferential wall 100 of the valve actuating apparatus 52. The nozzle 98 includes a shoulder 102 that abuts a bearing surface 104 of the valve actuating apparatus 52. Referring to FIG. SA, the wall 100 may include ribs 101 extending therefrom that engage the wall 108. In addition, the wall 100 may be tapered to facilitate insertion of the nozzle 98 therein. The nozzle 98 may include an inner circumferential wall 106 defining a flow passage and surrounded by an outer circumferential wall 108 connected to the inner circumferential wall 106 by radially extending members 110. The nozzle 98 may also have a flange 111 that abuts a lower periphery of the circumferential wall 100 as seen in FIG. 5. An outlet 112 is located at a discharge orifice 114 of the nozzle 98. Various conventional internal features can be selected so as to impart a desired spray characteristic to product discharged from the nozzle 98. Nozzles such as nozzle 98 are commercially available from Summit Packaging Systems, Inc. of Manchester, N.H.

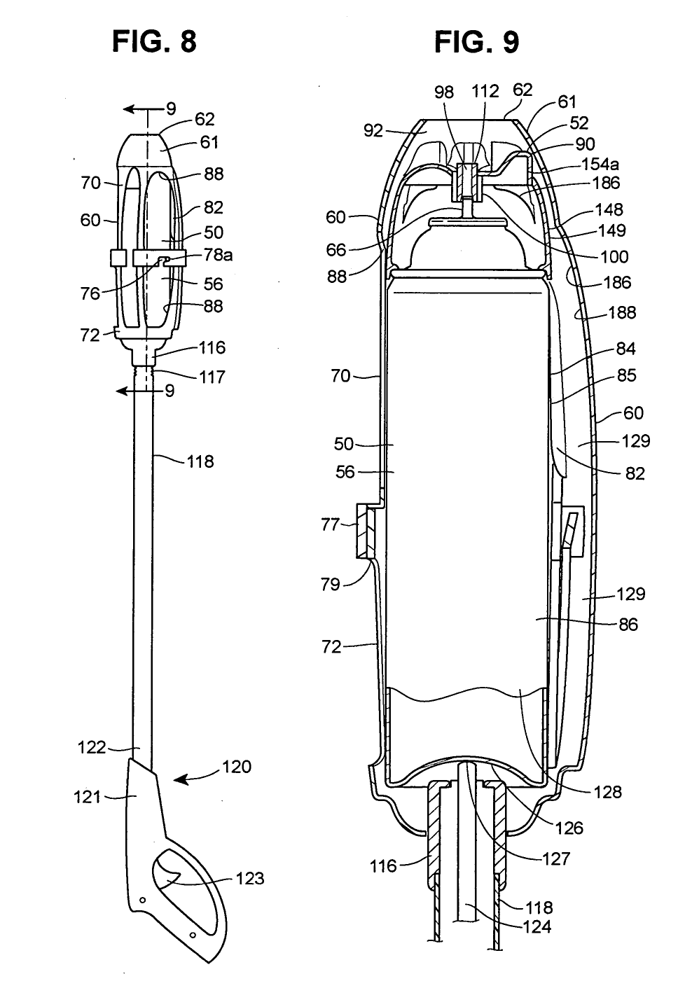

Referring to FIGS. 8 and 9, the housing 60 includes a sleeve 116 attached by any suitable means to a first end 117 of a hollow tube 118 of a rod and trigger mechanism 120. A handle assembly 121 is secured by any suitable means to a second end 122 of the hollow tube 118. Pulling a trigger 123 of the handle assembly 121 advances a push rod 124 (FIG. 9) disposed within the tube 118 against a bottom surface 126 of the container 50, thereby advancing the valve actuating apparatus 52 toward the discharge opening 62 to dispense product from the housing 60. If necessary or desirable, an end 127 of the push rod 124 may be shaped and/or fitted with a plate or other member to distribute forces more evenly across the bottom surface 126 of the container 50. Further, if desired, rather than moving the container 50 relative to the housing 60 using one or more intermediate members one could manually move the container 50 and/or the housing 60 relative to one another to dispense product.

Referring again to FIG. 5, a main region 129 of the wall portions 70 and 72 may have an inner cross sectional size C1 of about 66 mm, and thus the container 50 could have a cross sectional size of up to about 66 mm. In this regard, while a range of sizes is available for the container 50 one might wish to provide a container sized at or near maximum to provide a maximum useful life for the container 50 given the available space within the housing 60. One could select any suitable size for the discharge opening 62, such as a cross sectional size of about 34 mm, and suitable values of L might range between about 18 mm and about 33 mm to provide the above-described interfering relationship. A preferred value for L is about 25 mm.

The product stored within the container body 56 could be any of a broad variety of products such as an air freshener, an insect control agent, a hair spray, a cleaning agent, a polishing agent, a fragrance, or other any other product stored in a container. Further, the product may be pressurized by a suitable propellant disposed within the container 50.

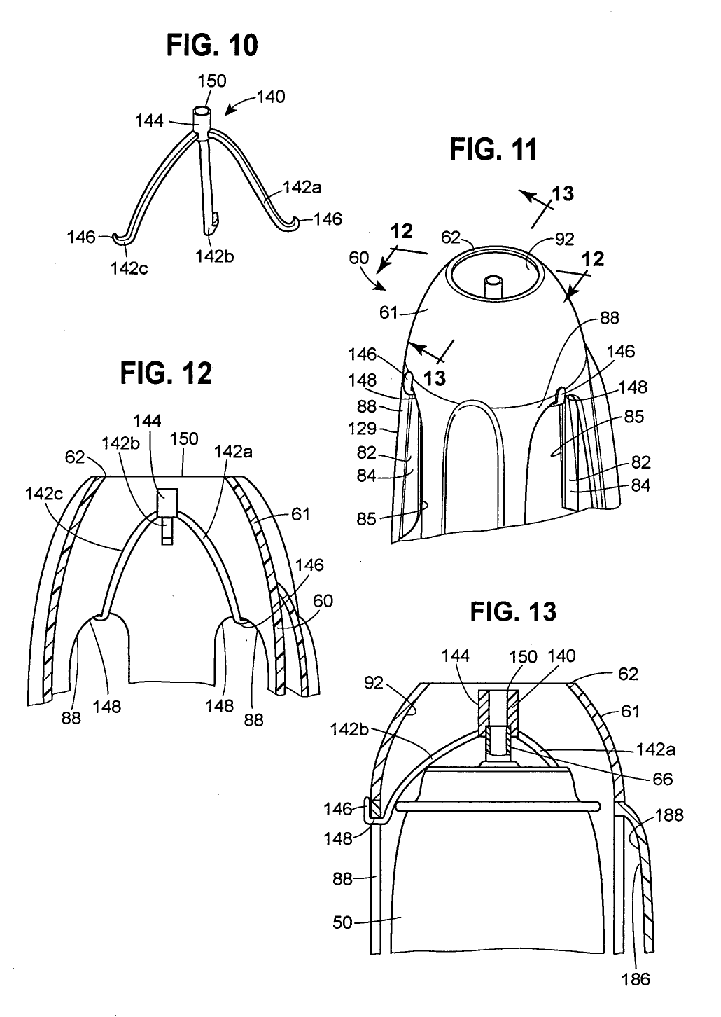

Referring now to FIGS. 10-13, an alternative valve actuating apparatus 140 includes a plurality of arms 142, such as three arms 142a-142c spaced apart from one another by 120 degrees. Each of the arms 142 extends from an adapter 144 that is fitted to the valve stem 66 shown in FIG. 13. Each of the arms 142 terminates at a hook member 146. Referring in particular to FIG. 13, providing a relative movement of the container 50 toward the discharge opening 62, as described above, causes the hook members 146 to engage against ledges 148 of the windows 88 such that the arms 142 pull the adapter 144 toward the container 50, thereby displacing the valve stem 66, causing product to discharge through a passage in the adapter 144, out of an opening 150 in the adapter 144, and out of the housing 60.

As should be evident from the foregoing, it is within the scope of the present invention for valve actuating apparatus to be disposed in interfering relationship with any suitable surface of the housing 60 other than the surface 92 of the tapered wall 61. For example, in the embodiment of FIGS. 10-13, the hook members 146 are disposed in interfering relationship with the ledges 148 of the windows 88.

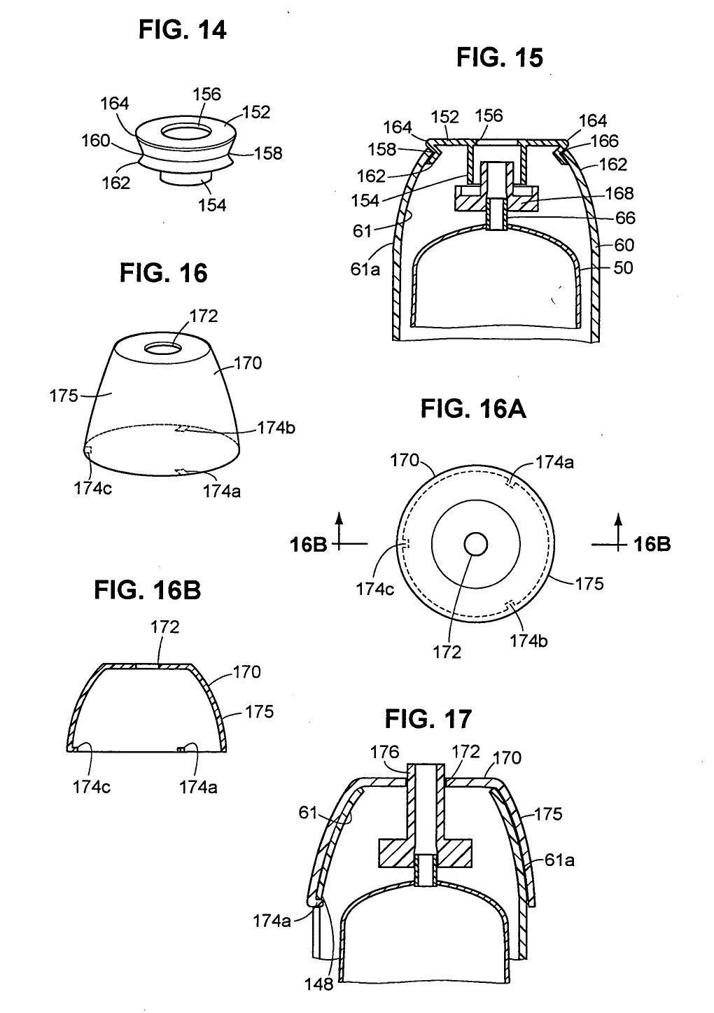

Referring to FIGS. 14 and 15, an embodiment of actuator adapter 152 is shown. The actuator adapter 152 includes a depending circumferential wall 154 and further includes a discharge opening 156. A peripheral side wall 158 includes a reduced diameter intermediate portion 160 and flange members 162, 164 on opposite sides thereof. The flange members 162, 164 capture an edge 166 of the housing 60 therebetween to retain the adapter 152 on the housing 60. The adapter 152 should be sufficiently flexible to allow flexing of the flange member 162 and permit insertion of the adapter 152 into the discharge opening 62. Referring in particular to FIG. 15, it should be appreciated that providing relative movement of the container 50 and the housing 60 as discussed above causes product to dispense from the housing 60. A generally cylindrical valve actuating apparatus 168 is fitted to and extends from the valve stem 66. During relative movement of the container 50 toward the discharge opening 62, the valve actuating apparatus 168 engages the circumferential wall 154, thereby displacing the valve stem 66 such that product flows out of the discharge opening 156.

Referring to FIGS. 16 and 17, another adapter 170 includes a discharge opening 172 as well as a plurality of tabs 174, such as three tabs 174a-174c, circumferentially separated from one another by 120 degrees. As shown in FIG. 17, the tab 174a fits around and engages one of the three ledges 148 of the three windows 88 of the housing 60. Further, the tabs 174b and 174c fit around and engage the other of the ledges 148 of the housing 60. It should be noted that a main wall 175 of the adapter 170 is preferably molded to closely fit with an outer surface 61a of the wall 61. Further, the tabs 174a-174c are preferably molded so that the tabs 174a-174c are biased toward the interior of the housing 60 to provide a suitable interfering relationship with the ledges 148. A valve actuating apparatus 176 may be fitted to the valve stem 66 and also secured to the adapter 170 such that apparatus 176 is stationary relative to the adapter 170 during relative movement of the container 50 and the housing 60. Referring again to FIG. 15, it should be noted that while FIG. 15 shows the apparatus 168 not secured to the insert 152, one could alternatively secure the apparatus 168 to the insert 152 such that the apparatus 168 functions in a manner similar to the apparatus 176 shown in FIG. 17.

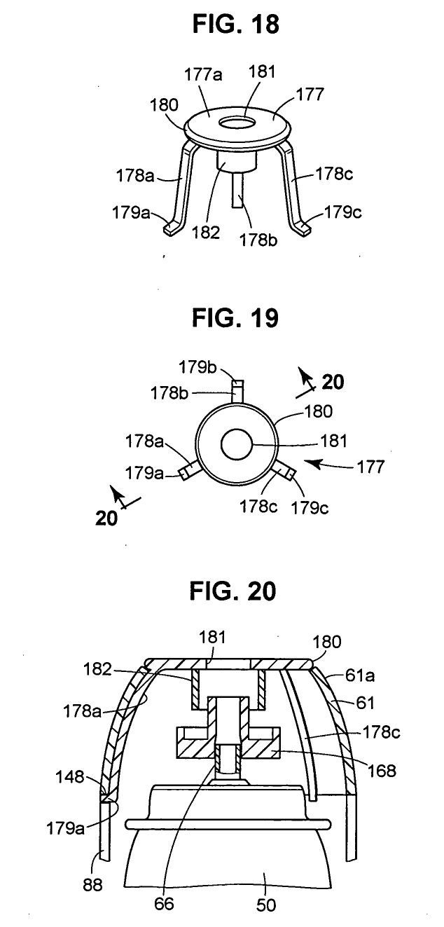

Referring to FIGS. 18-20, a third actuator adapter 177 includes a main portion 177a and a plurality of legs 178, such as three legs 178a-178c circumferentially spaced apart by 120 degrees. The legs 178a-178c include feet 179a-179c that may be disposed in interfering with relationship with the ledges 148. A circumferential shouldered portion 180 of the main portion 177a and the feet 179 capture the wall 61 therebetween to retain the adapter 177 to the housing 60. The adapter 177 further includes a discharge opening 181. The adapter 177 includes a circumferential wall 182 similar to the wall 154 of FIG. 15. The valve actuating apparatus 168 is disposed on the valve stem 66, as in the embodiment of FIG. 15. Relative movement of the container 50 and the housing 60 causes the valve actuating apparatus 168 to engage against the circumferential wall 182 such that product discharges out of the discharge opening 181 and out of the housing 60.

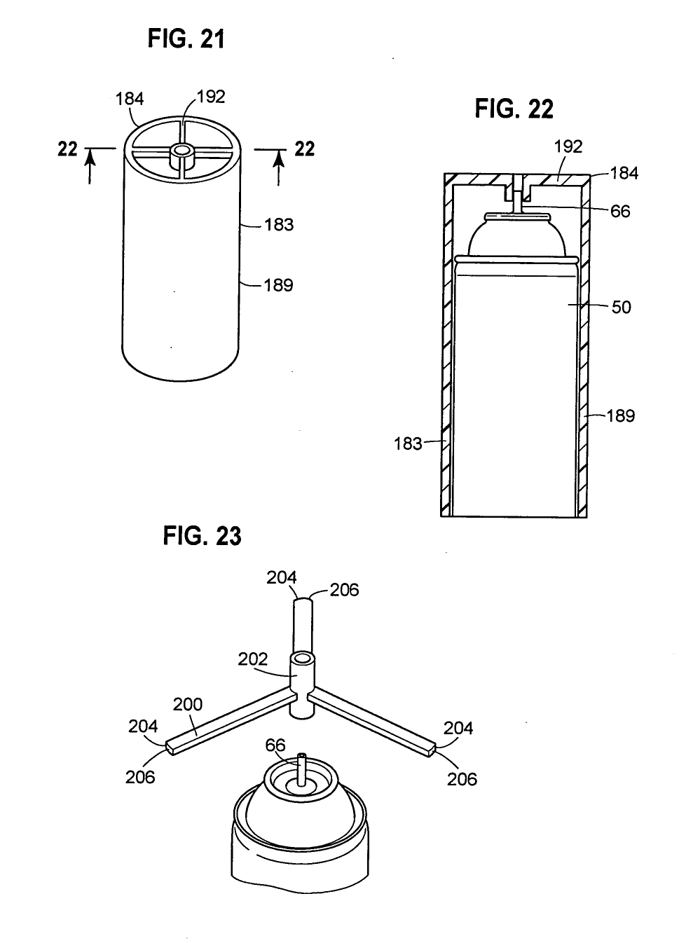

FIGS. 21 and 22 show a cage 183 in which the container 50 may be placed. A peripheral edge 184 of the cage 183 is disposed in interfering relationship with any suitable surface of the housing 60 when the cage 183 is placed within the housing 60. For example, the peripheral edge 184 may be disposed in interfering relationship with the ledges 148 of the windows 88. Alternatively, the peripheral edge 184 could be disposed in interfering relationship with a different surface. For example, referring to FIG. 9, the edge 184 may interfere with a surface 186 of a recessed wall portion 188. As a further alternative, a circumferential flange (not shown) could be disposed on a lower exterior surface 189 of the cage 183 and such flange could be disposed in interfering relationship with lower surfaces 190 (FIG. 2) of the fins 84. Valve actuating apparatus 192 integral with the cage 183 is secured to the valve stem 66. Moving the container 50 toward the discharge opening 62 engages the edge 184 against the surface 186 (FIG. 9) or the ledges 148 such that the valve stem 66 is displaced into the container 50 to discharge product. While the valve actuating apparatus 192 is shown as integral with the cage 182, the apparatus 192 could be separate from the cage 183, and/or disposed in interfering relationship with an appropriate surface or flange (not shown) provided in the cage 183.

Referring to FIG. 23, a further embodiment of valve actuating apparatus 200 includes an adapter 202 that fits on the valve stem 66. One or more arms 204 extend radially from the adapter 202. Each of the arms 204 includes an outer peripheral surface 206 disposed in interfering relationship with any suitable surface of the housing 60. For example, the outer peripheral surfaces 206 may be disposed in interfering relationship with the ledges 148 of the windows 88, or alternatively the surface 186 shown in FIG. 9.

Methods of dispensing may be practiced according to the present invention. For example, a user may select one of the adapters 152, 170, or 177 (FIGS. 15, 16, and 18), and may fit such adapter to the housing 60. The user may then provide relative movement of the container 50 and the housing 60 as described above such that suitable valve actuating apparatus extending from the container 50, such as the apparatus 168, is engaged by the adapter 152, 170, 177 to discharge the product from the housing 60. A further method of dispensing may include placing the container 50 along with the valve actuating apparatus 200 of FIG. 23 into the housing 60 and providing relative movement of the container 50 and the housing 60 such that the outer peripheral surfaces 206 engage the ledges 148 of the windows 88, causing displacement of the valve stem 66 and consequent discharge of product from housing 60. An additional dispensing method employs the cage 183 shown in FIG. 21, and a relative movement of the container 50 and the housing 60 is provided to dispense product.

In addition, one might also practice methods of providing valve actuating apparatus to an end user. In a first such method, one may provide the container 50 and one of the adapters 152, 170, or 177 and then deliver these to an end user through any suitable form of delivery or distribution, whether by distribution through stores, promotional events, United States mail, common carrier, or other suitable sales or distribution channels. It should be noted that the container 50 and the adapter 152, 170, or 177 need not be sold to a consumer in every instance, but either or both of these items could instead be given away without charge for promotional purposes. It should also be noted that while the container 50 and the adapter 152, 170, or 177 are preferably distributed at the same time, these items could be distributed at different times so long as at some point in time the end user is in possession of both the container 50 and the adapter 152, 170, 177 for use with the housing 60. A further optional step includes identifying the adapter 152, 170, or 177 as usable with the housing 60. This identification may take many forms sufficient to indicate to the end user that the adapter 152, 170, 177 may be fitted to the housing 60. For example, the adapter 152, 170, or 177 and/or the container 50 provided therewith could simply be affirmatively identified as intended or suited for use with an existing commercial product that is equipped with the housing 60. The identification could include written directions for using the container 50 and the adapter 152, 170, or 177 and these directions could be sold with the container 50 and/or the adapter 152, 170, or 177. Alternatively, the identification may be in the form of one or more pictorial diagrams that illustrate a housing having a tapered wall or diagrams of the container 50 and the adapter 152, 170, or 177 used with the housing 60.

In an alternative method of providing valve actuating apparatus to an end user, one may provide the container 50 along with the cage 184 (FIG. 21) and deliver these to an end user in any of the ways discussed above. The cage 184 (FIG. 21) is identified as usable with the housing 60 in any of the ways discussed above. Alternatively, one might provide and deliver the container 50 and the valve actuating apparatus 200 (FIG. 23). As a further alternative, one might provide and deliver the container 50 with the adapter 140 (FIG. 10). The valve actuating apparatus 200 or the adapter 140 are identified as usable with the housing 60 in any of the ways described above.

### INDUSTRIAL APPLICABILITY

The foregoing embodiments are useful for dispensing a variety of products such as insecticides, cleaning products, air treatment products (e.g., air fresheners), or other products.

Numerous modifications to the present invention will be apparent to those skilled in the art in view of the foregoing description. Accordingly, this description is to be construed as merely exemplary of the inventive concepts taught herein and is presented for the purpose of enabling those skilled in the art to make and use the invention and to teach the best mode of carrying out same. The exclusive rights to all modifications which come within the scope of the appended claims are reserved.

1. A combination, comprising:
a container of product having a longitudinal dimension and a valve oriented to discharge product generally longitudinally from the container;
a housing including a first wall portion enclosing a main body of the container and a second tapered wall portion adjacent the first wall portion tapering to a discharge opening wherein the discharge opening has a cross sectional size larger than a radius of the container; and
valve actuating apparatus extending laterally from the valve and having an interfering relationship with the first wall portion wherein relative movement of the container toward the discharge opening causes the valve actuating apparatus to be displaced against the first wall portion to actuate the valve and dispense product from the housing.

2. A combination, comprising:
a container of product having a longitudinal dimension and a valve oriented to discharge product generally longitudinally from the container;
a housing including a first wall portion enclosing a main body of the container and a second tapered wall portion adjacent the first wall portion tapering to a discharge opening wherein the discharge opening has a cross sectional size larger than a radius of the container; and
an adapter fitted to the housing wherein relative movement of the container toward the discharge opening causes a surface of the adapter to contact valve actuating apparatus of the container to actuate the valve and dispense product from the housing.

3. The combination of claim 2, wherein the adapter includes a projection member extending inside of the housing.

4. The combination of claim 2, wherein the adapter is fitted to the second wall portion.

5. A method of dispensing, the method comprising the steps of:
selecting a container of product and valve actuating apparatus wherein the container has a longitudinal dimension and has a valve oriented to discharge product generally longitudinally from the container;
selecting a housing having a first wall portion enclosing a main body of the container and a second tapered wall portion adjacent the first wall portion wherein the second wall portion tapers to a discharge opening and wherein the discharge opening has a cross sectional size larger than a radius of the container;
placing the container within the housing wherein the valve actuating apparatus extends laterally from the valve and has an interfering relationship with the first wall portion; and
providing a relative movement of the container toward the discharge opening such that the valve actuating apparatus is displaced against the first wall portion to actuate the valve and dispense product from the housing.

6. The method of claim 5, wherein the valve actuating apparatus includes an extension member terminating at a hook member wherein the hook member interferes with a surface of the first wall portion.

7. The method of claim 6, further comprising an additional extension member.

8. The method of claim 5, wherein the valve actuating apparatus includes first, second, and third extension members and wherein each of the extension members terminates at a hook member and the hook members interfere with surfaces of the first wall portion.

9. The method of claim 5, wherein the valve actuating apparatus is disposed in interfering relationship with a surface of the first wall portion and wherein the surface is a ledge defined by a further opening disposed in the first wall portion.

10. The method of claim 5, wherein the first wall portion is tapered and includes a plurality of guide fins, the valve actuating apparatus having an interfering relationship with at least one of the guide fins.

11. The method of claim 5, wherein the valve actuating apparatus is disposed in interfering relationship with a plurality of surfaces of the first wall portion.

12. A method of dispensing, the method comprising the steps of:
selecting a container of product having a longitudinal dimension and having a valve oriented to discharge product generally longitudinally from the container;
selecting a housing having a first wall portion enclosing a main body of the container and a second tapered wall portion adjacent the first wall portion wherein the second wall portion tapers to a discharge opening and wherein the discharge opening has a cross sectional size larger than a radius of the container;
fitting an adapter to the housing; and
providing a relative movement of the container toward the discharge opening such that valve actuating apparatus of the container engages a surface of the adapter to actuate the valve and dispense product from the housing.

13. The method of claim 12, wherein the adapter includes a projection member extending inside of the housing

14. The method of claim 12, wherein the adapter is joined to the second wall portion.

15. The method of claim 14, wherein the adapter is joined to an outside surface of the second wall portion.

16. The method of claim 14, wherein the adapter is joined to an inside surface of the second wall portion.

17. A method of providing apparatus to an end user, the method comprising the steps of:
providing a valve actuating adapter;
causing the valve actuating adapter to be delivered to the end user;
identifying the valve actuating adapter as fittable to a housing having a first wall portion that encloses a main body of the container and a second tapered wall portion adjacent the first wall portion wherein the second wall portion tapers to a discharge opening having a cross sectional size larger than a radius of the container.

18. The method of claim 17, further comprising providing a container of product to the end user.

19. The method of claim 17, wherein the end user is instructed to move a container of product within the housing toward the discharge opening such that the container presses against the valve actuating adapter thereby actuating a valve of the container to dispense product from the housing.

20. The method of claim 17, wherein the adapter includes a projection member extending inside of the housing.

21. The method of claim 17, wherein the valve actuating apparatus is joined to the second wall portion.

22. A method of providing apparatus to an end user, the method comprising the steps of:
providing a container of product having a longitudinal dimension and valve actuating apparatus extending in a direction transverse to the longitudinal dimension and terminating at an outer peripheral surface;
causing the container to be delivered to the end user; and
identifying the container and the valve actuating apparatus as suitable for placement within a housing that has a first wall portion that encloses a main body of the container and a second tapered wall portion adjacent the first wall portion that tapers to a discharge opening wherein the discharge opening has a cross sectional size larger than a radius of the container wherein product can be dispensed by moving the container and the housing relative to each other in a direction along the longitudinal dimension to displace the valve actuating apparatus against a surface of the first wall portion.

23. The method of claim 22, wherein the valve actuating apparatus is a cage enclosing the main body of the container and wherein the cage is disposed in interfering relationship with a surface of the first wall portion.

24. The method of claim 22, wherein the valve actuating apparatus is fitted to a valve stem of the container.

25. The method of claim 22, wherein the valve actuating apparatus includes an extension member terminating at a hook member wherein the hook member interferes with a surface of the first wall portion.

26. The method of claim 25, wherein the valve actuating apparatus includes an additional extension member.

27. The method of claim 22, wherein the valve actuating apparatus includes first, second, and third extension members and wherein each of the extension members terminates at a hook member and the hook members interfere with surfaces of the first wall portion.
